(19) United States
(12) Patent Application Publication
(10) Pub. No.: US 2025/0060742 A1
(43) Pub. Date: Feb. 20, 2025

(54) CONNECTED WATER MONITORING SYSTEM AND METHOD

(71) Applicant: Pentair Residential Filtration, LLC, Brookfield, WI (US)

(72) Inventors: Blake BREWER, Bartlett, IL (US); Kurt R. KAISER, Hanover Park, IL (US); Sam WILLIAMS, Hanover Park, IL (US)

(21) Appl. No.: 18/723,800

(22) PCT Filed: Dec. 28, 2022
(86) PCT No.: PCT/US2022/082496

§ 371 Date: Jun. 24, 2024

Related U.S. Application Data
(60) Provisional application No. 63/266,161, filed on Dec. 29, 2021.

(51) Int. Cl. G05B 23/02

(52) U.S. Cl. CPC G05B 23/0283

(57) ABSTRACT

A connected water monitoring system including a plurality of sensors, each of which monitors a respective condition is provided. A hub device receives and stores respective information from each of the plurality of sensors indicative of a current status of the respective condition monitored by a respective one of the plurality of sensors. A cloud server communicates with the hub device via a network. The respective information includes one or more values sensed by each of the plurality of sensors. The hub device transmits one or both of the one or more values or the respective information to the cloud server. The cloud server determines when one or both of the one or more values or the respective information from each of the plurality of sensors indicate that one or more connected water monitoring system components require maintenance and, responsive thereto, execute an automatic maintenance process.

### RELATED APPLICATIONS

This application claims priority to U.S. Provisional Application No. 63/266,161, filed on Dec. 29, 2021, the entire disclosure of which is incorporated herein by reference.

### BACKGROUND

As the cost of microprocessors and other computing components has decreased, there has been expanded use of such components to create network-connected systems for monitoring the performance characteristics of water supply and/or filtration systems used in home and/or commercial applications. However, such existing systems do not fully utilize these increased capabilities to provide users with comprehensive monitoring capabilities and related support services, such as automated setup, support, and maintenance procedures. Furthermore, existing solutions have not included preconfigured kits of sensors directed to specific types of systems. In light of these failings, there is a need for improved systems and methods.

### SUMMARY

Some embodiments provide a connected water monitoring system including a plurality of sensors, each of which monitors a respective condition. The system further includes a hub device configured to receive and store respective information from each of the plurality of sensors indicative of a current status of the respective condition monitored by a respective one of the plurality of sensors. A cloud server is configured to communicate with the hub device via a network. The respective information includes one or more values sensed by each of the plurality of sensors. The hub device is configured to transmit one or both of the one or more values or the respective information from each of the plurality of sensors to the cloud server. The cloud server is configured to determine when one or both of the one or more values or the respective information from each of the plurality of sensors indicate that one or more connected water monitoring system components require maintenance and, responsive thereto, execute an automatic maintenance process.

In some forms, the hub device includes an application program interface through which one or more values are set or updated via a user device connected to the hub device via one or both of the cloud server or a direct network connection. The plurality of sensors can include one or more of a total dissolved solids sensor, a flow meter, a pressure meter, a temperature sensor, or a salt level sensor. The connected water monitoring system can include a kit that includes the plurality of sensors and the hub device, and the kit can include a unique identifier associated therewith. The connected water monitoring system can include a user device configured to scan the unique identifier and use the unique identifier to retrieve a setup procedure for the hub device and the kit. The setup procedure can include instructions for uploading a default configuration for the hub device from one or both of the user device or the cloud server, wherein the default configuration includes initial hub device settings for each of the plurality of sensors. The cloud server can be configured to determine that one or both of the one or more values or the respective information from each of the plurality of sensors indicate that the one or more connected water monitoring system components require maintenance when one or both of the one or more values or the respective information from each of the plurality of sensors indicate that the system is currently performing below a threshold level of operation.

In some forms, the cloud server can be configured to determine that one or both of the one or more values or the respective information from each of the plurality of sensors indicate that the one or more connected water monitoring system components require maintenance when one or both of the one or more values or the respective information from each of the plurality of sensors indicate that the system will be performing below a threshold level of operation at a future point in time. The automatic maintenance process can include the cloud server identifying one or more of repairs to or replacements of the one or more connected water monitoring system components and transmitting a maintenance notification to a service provider. The maintenance notification includes a list of the one or more of repairs to or replacements of the one or more connected water monitoring system components. When the cloud server determines that the system will be performing below the threshold level of operation at the future point in time, the automatic maintenance process can include determining that the one or more connected water monitoring system components will reach an end-of-life condition at a future point in time and ordering a replacement of the one or more connected water monitoring system components such that the replacement is delivered on or before the future point in time.

Some embodiments provide a method of monitoring a water flow system. The method includes providing a connected water monitoring system having a sensor and a hub device configured to receive information from the sensor indicative of a current status of the water flow system. The method further includes the step of sensing one or more values corresponding to water flowing through the water flow system with the sensor, and transmitting the one or more values to the hub device. The one or more values are transmitted from the hub device to a cloud server. The one or more values are analyzed to predict whether one or more components of the water flow system will perform below a threshold level of operation at a future point in time. A notification is sent that indicates an action to be taken before the future point in time.

In some forms, the action includes replacing a filter cartridge. The action can include shutting off a valve. The action can include replacing a battery of the sensor. The hub device can include a light ring, and the method can further include illuminating the light ring based on the current status of the water flow system. The hub device can include a light ring, and the method can further include illuminating the light ring based on a connectivity status between the sensor and the hub device. The method can further include generating a contextualized report over multiple time periods based on the one or more values corresponding to water flowing through the water flow system. The action can be initiated automatically by the connected water monitoring system. The action can include automatically increasing the production of a reverse osmosis component of the water flow system. The action can include modifying a function of a smart component of the water flow system.

### DESCRIPTION OF THE DRAWINGS

FIG. 1 is a schematic block diagram of a connected water monitoring system according to disclosed embodiments;

FIG. 2 is a schematic block diagram of a connected water monitoring system according to disclosed embodiments;

FIG. 3 is an isometric view of a hub device according to disclosed embodiments;

FIG. 4 is an isometric view of a total dissolved solids sensor according to disclosed embodiments;

FIG. 5 is a schematic block diagram of a first sensor kit according to disclosed embodiments;

FIG. 6 is a schematic block diagram of a second sensor kit according to disclosed embodiments;

FIG. 7 is a schematic block diagram of a third sensor kit according to disclosed embodiments;

FIG. 8 is a schematic block diagram of a fourth sensor kit according to disclosed embodiments; and

FIG. 9 is a view of an exemplary status dashboard according to disclosed embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Embodiments disclosed herein are generally directed to connected water monitoring systems and methods executed by the connected water monitoring system. Such systems and methods can include various kits of components, such as sensors, configured to be retrofittable into existing residential and/or commercial water infrastructure, such as filtration systems, reverse osmosis systems, water softening systems, or other water applications involving the flow, processing, and/or treatment of water. In some embodiments, such kits can be configured to communicatively connect the existing water infrastructure with local and/or cloud-based software application infrastructure to execute various methods, including, for example, local and/or remote monitoring of system alerts, error codes, and/or conditions, controlling system settings, automatically fulfilling replacement parts, and/or accessing support services customized to a specific kit added into the existing water infrastructure. For example, as described in more detail below, in some embodiments, the software application infrastructure can be configured to receive data from the components in the kits and process the data, along with other system alerts, error codes, etc., to generate contextualized reports and/or user interface graphics that can quickly and intelligibly inform a service provider and/or a user about the status of the existing water infrastructure, the components in the kits, and any related sub-components.

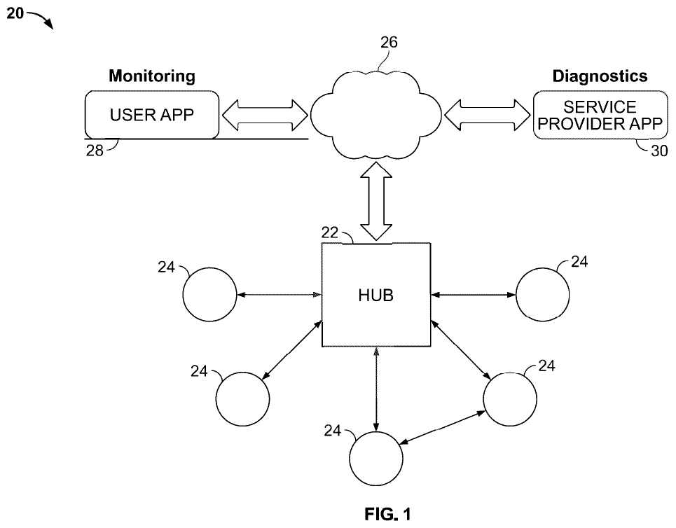

FIG. 1 broadly illustrates a schematic block diagram of a connected water monitoring system 20 according to disclosed embodiments. As seen in FIG. 1, the connected water monitoring system 20 can include a hub device 22, one or more sensors 24, a cloud server 26, a user device executing an application 28 thereon, and a service provider device executing an application 30 thereon. In some embodiments, the hub device 22 can be configured to communicate with the cloud server 26 via a communication network. Various embodiments for the communication network are contemplated including, but not limited to, the internet, a cellular network, a phone line network, and/or other public or proprietary network types known to persons having ordinary skill in the art. In some forms, the hub device 22 acts as a communication gateway between the sensors 24 and the cloud server 26. In some embodiments, the hub device 22 can be powered by an AC voltage wall outlet. Additionally or alternatively, in some embodiments, the hub device 22 can be powered by a direct current battery, a rectifier, and/or an inverter individually, or as a combination, as understood in the art.

In some embodiments, each of the plurality of sensors 24 can continuously, frequently, and/or periodically monitor a respective condition within the connected water monitoring system 20 and remotely transmit respective data indicative thereof, for example, to the hub device 22 via wired or wireless communication. In some forms, the sensors 24 also transmit data to each other through wired or wireless communication. In some embodiments, any of the plurality of sensors 24 can include a total dissolved solids (TDS) sensor, such as the TDS sensor 48 (scc FIG. 4), that can monitor an amount of dissolved solids present in, or the temperature of, water that passes through the TDS sensor 48. In some embodiments, the TDS sensor can be used to monitor a level of salt dissolved in water flowing through the system. In these embodiments, a very high TDS value can indicate that too much salt is in the water monitored by the system 20. The plurality of sensors 24 may also include a flow meter sensor, such as a low flow sensor 56 (see FIG. 6) or a high flow sensor 64 (see FIG. 7), that can monitor a flow rate of water. The plurality of sensors 24 may further include a pressure sensor, such as the pressure sensor 62 (see FIG. 7). Still further, the plurality of sensors 24 may also include one or more of a salt level sensor that can detect a level of remaining salt supply in a brine tank for a water softener, for example, a leak detector that can detect a leak in a water supply line, a bypass detector that can detect whether the water supply line has been bypassed, a temperature sensor, and/or an electrical pump sensor to detect aspects of pump function such as pump motor power consumption. In some embodiments, the high flow sensor 64 can detect when the flow rate exceeds a first predetermined value, and the low flow sensor 56 can detect when the flow rate falls below a second predetermined value. It should be appreciated that one or more sensors 24 may be used in the systems disclosed herein.

In some embodiments, the functionality of one or more of the aforementioned embodiments of the plurality of sensors 24 can be inferred from values of other ones of the plurality of sensors 24. For example, in some embodiments, the hub device 22 and/or the cloud server 26 can use water flow data from one or more of the low flow sensor 56, the high flow sensor 64, and/or the pressure sensor 62 to determine whether there is a water leak in the system 20. Additionally or alternatively, the hub device 22 and/or the cloud server 26 can use the water flow data to determine whether a bypass condition is present in the system 20. In these embodiments, the aforementioned leak detector and bypass detector can be omitted. Alternatively, the leak detector and the bypass detector may be deployed in the system 20 for direct leak and bypass detection, and also the detected leak and/or bypass conditions can be verified via inferences from other sensors 24 in the system 20. Similarly, the information from the plurality of sensors 24 can be used to identify other changes for the system 20 such as identifying the installation of new plumbing.

In some embodiments, one or more of the sensors 24 can be contained in a single sensor package with a communal inflow port and a communal outflow port. Additionally or alternatively, each of the plurality of sensors 24 can include respective interface connectors, tolerances, and operational requirements as known in the art. For example, the flow meter sensor can include a ⅜ inch F-nut inflow connector, a ⅜ M nut outflow connector, an operating pressure range of approximately 29-116 psi (2-8 bar), an operating flow rate of 3-26 GPH (10-100 LPH), a pressure loss of 3 psi at 26 GPH, a precision (horizontal installation) of +/−5% or more, a water temperature operating range of approximately 39-86° F. (4-30° C.), and/or an ambient temperature operating range of approximately 39-104° F. (4-40° C.). In some forms, the sensors 24 can include push to connect tube fittings for easy in-line installation. In any embodiment, any of the plurality of sensors 24 can be battery-powered and configured to operate at low power to enable life for up to one year or more. Also, any of the plurality of sensors 24 can include one or more buttons and status indicator lights for use in setting up and/or monitoring the operation, power status, and/or connectivity of a respective one of the plurality of sensors 24.

In some embodiments, the connected water system 20 can include various other IoT enabled or communicatively connected smart components. For example, in some embodiments, the connected water monitoring system 20 can include controllable devices, such as a first smart valve that can be configured to shut off a water supply. Accordingly, the first smart valve can prevent damage from leaks detected by the connected water monitoring system 20. In another embodiment, a second smart valve and/or actuators can be configured to remotely adjust a blend of additive chemicals or other materials that are introduced into the water supply managed by the connected water monitoring system 20. For example, if the TDS value sensed is too low when compared to a TDS threshold value, the second smart valve can introduce a higher blend flow rate of unfiltered, municipal water into the flow of water to introduce more dissolved minerals. Additionally, in some embodiments, the smart components can include one or more smart appliances such as an ice maker, espresso machine, coffee maker, beverage dispenser, or the like. In these embodiments, the hub device 22 and/or the cloud server 26 can be configured to shut down the smart appliance and/or trigger an alert related thereto based on the information received from the plurality of sensors 24 and/or one or more values calculated or directly measured therefrom. For example, in some embodiments, the hub device 22 and the cloud server 26 can be configured to send an icemaker into an alert mode if a minimum pressure value in the connected water system 20 is not achieved. Additionally or alternatively, in some embodiments, the hub device 22 and the cloud server 26 can be configured to shut down an espresso machine if a required amount of pressure (e.g. approximately 20 psi) has not been achieved in the connected water system 20. Similarly, in some embodiments, the hub device 22 and the cloud server 26 can be configured to automatically increase the production of a reverse osmosis component of the system 20 when changes in water temperature are identified by one or more of the plurality of sensors 24.

According to embodiments disclosed herein, the hub device 22 and the cloud server 26, either together or independently, can receive and/or process information from any of the plurality of sensors 24 and/or any of the other smart components of the system 20 to calculate one or more values related to the operational, maintenance, or general status of the system 20. In some embodiments, the values, such as an average value or a differential value, can then be compared to various thresholds such as a minimum value or a maximum value of the respective condition monitored by one or more of the plurality of sensors 24. For example, in some embodiments, the hub device 22 can be configured to receive and store the information from any of the plurality of sensors 24 and/or any of the other smart components of the system 20. For example, the hub device 22 and/or the cloud server 26, can store one or more threshold values such as a minimum TDS value, a maximum TDS value, a minimum pressure value, a maximum pressure value, a minimum flow value, or a maximum flow value. Accordingly, information from the plurality of sensors 24 and/or the calculated values therefrom can be compared with the stored threshold values to determine if any of the sensed or calculated values are out of range (e.g., above or below the threshold value or acceptable operational range). In some forms, the plurality of sensors 24 themselves can store various threshold values, and in place of, or in addition to, communication sensed values, the plurality of sensors 24 can communicate exceeded threshold conditions to the hub device 22 and/or the cloud server 26. In this way, abnormalities with the devices used in the residential and/or commercial water infrastructure being monitored can be detected, alerts or notifications can be issued, maintenance can be performed, and/or the function of various smart components of the system 20 can be modified to regulate the values sensed by the plurality of sensors 24.

In some embodiments, the information received from one of the plurality of sensors 24 can be indicative of a current status of the respective condition monitored by that sensor 24. Furthermore, in some embodiments, the hub device 22 can be configured to calculate the values using the information received from any of the plurality of sensors 24. In some forms, the information or calculated values indicate the status of the plurality of sensors 24 or the hub device 22, such as whether one or more of the plurality sensors 24 are running low on battery power, have connectivity issues with each other, or the hub 22, or whether the hub 22 has WI-FI, cellular, or other network connectivity issues. In some embodiments, the hub device 22 can be configured to transmit the values and/or the information received from any of the plurality of sensors 24 to the cloud server 26. In some embodiments, the hub device 22 can be configured to receive updates to its operating software and/or firmware or the operating software and/or firmware of the plurality of sensors 24 from the cloud server 26 or an over the air connection. In some forms, the hub device 22 and/or the cloud server 26 include an error log that aggregates errors that have occurred in the functionality of the hub device 22 itself or the plurality of sensors 24. For example, the error log can keep track of instances that the plurality of sensors 24 and/or the hub device 22 experience failures in network connectivity, connectivity to each other, low battery or other power failures, defunct or omitted sensing by any of the plurality of sensors 24, or malfunctions in firmware or software.

In some embodiments, the hub device 22 can include an application program interface (API) through which the values can be identified or updated via the user device and the application 28 executed thereon, and in some embodiments, the hub device 22 can include a local memory or similar digital storage or database device that can store the one or more values and/or the information received from any of the plurality of sensors 24. The hub device 22 can be configured to store the values and the information received from any of the plurality of sensors 24 for a preconfigured time period that is identified through the API, such as for 3 days. Additionally or alternatively, in some embodiments, the hub device 22 can be configured to locally store only a minimum number of historical values, and the information received from each of the plurality of sensors 24 needed to calculate/update the values in response to the hub device 22 receiving updates to the information received from any of the plurality of sensors 24. For example, in some embodiments, the minimum number of historical values might be only the most recently or last calculated and received ones of the values and the information received from each of the plurality of sensors 24.

Additionally or alternatively, in some embodiments, the hub device 22 can be configured to determine when connectivity to the cloud server 26 is lost and then subsequently restored. In these embodiments, the hub device 22 can be configured to disregard any configuration settings limiting the amount of locally saved data but cache all changes in the values and the information received from any of the plurality of sensors 24 from when the connectivity with the cloud server 26 is lost to when connectivity is subsequently restored, and upload such cached data to the cloud server 26 automatically in response to the connectivity being restored. Similarly, in some embodiments, the hub device 22 can be configured to save any of the values and the information received from each of the plurality of sensors 24 that have not been uploaded to the cloud server 26 to prevent loss of such data in the event of a local power failure.

Various embodiments for the frequency at which the values and/or the information received from any of the plurality of sensors 24 are uploaded from the hub device 22 to the cloud server 26 are contemplated. For example, in some embodiments, the information received from the TDS sensor 48 can be uploaded hourly or a pre-configured number of times per day (e.g., every 30 minutes, hour, two hours, four hours, 8 hours, 12 hours, or 24 hours, or 1 time per day, 2 times per day, 3 times per day, 4 times per day, 5 times per day, 6 times per day, or more) with hourly data being backfilled. In one specific embodiment, the information received from the flow meter sensors 56, 64 and the pressure sensor 62 can be uploaded with corresponding values every 4 hours. In these embodiments, the information received from the flow meter sensors 56, 64 and the pressure sensor 62 and the values can include one or more of a current flow rate through the system 20, a minimum, a maximum, and an average flow rate over a certain period of time, a current pressure in the system 20, and a minimum, a maximum, and/or an average pressure rate over a certain period of time. In some embodiments, the minimum, the maximum, and the average flow rate and the minimum, the maximum, and the average pressure rate can be determined between a current time and a previous time when data was last uploaded to the cloud server 26. In some embodiments, the hub device 22 can be configured to transmit the information received from each of the plurality of sensors 24 to the cloud server 26 without any additional calculations. In these embodiments, the cloud server 26 can be configured to calculate the one or more values as described herein and can include an API through which the values can be identified or updated from the information received from the plurality of sensors 24.

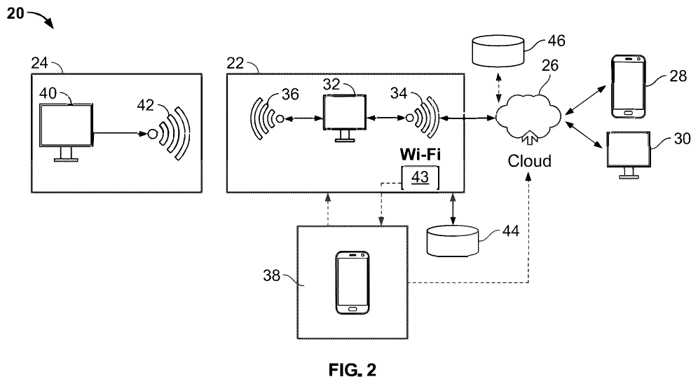

FIG. 2 more specifically illustrates aspects of the connected water monitoring system 20 with additional details of the hub device 22, the plurality of sensors 24, and the cloud server 26 according to disclosed embodiments. As seen in FIG. 2, the hub device 22 can include a processor 32, a WI-FI communication interface 34 for communicating with the cloud server 26, a short-range communication module 36 for communicating with a respective processor 40 of each of the plurality of sensors 24 via a respective short-range communication module 42 thereof, and in some embodiments, a cellular radio module 38 for communicating with the cloud server 26 in lieu of, or in addition to, the WI-FI communication interface 34. The WI-FI communication interface 34 can be configured to communicate via a router to the cloud 26 or directly to the cloud 26. The short-range communication modules 36 and 42 can provide communication through a mesh network protocol, such as Thread protocol and a 2.4 GHz carrier or a 915 MHz carrier, or another peer-to-peer network (e.g., a Bluetooth network, a ZigBee® network, a Z-Wave® network, a proprietary RF connection, etc.). In some forms, when any of the plurality of sensors 24 are in the range of the hub device 22, the sensors 24 will automatically establish short-range communication with the hub device 22. The cellular radio module 38 can provide cellular communication between the processor 32 and the cloud 26. In some forms, the hub device 22 is configured to automatically switch between using cellular communication and WI-FI communication to communicate with the cloud server 26 based on the availability of a cellular network or a WI-FI network.

In some embodiments, the cellular radio module 38 can be integrated into a single housing with other components of the hub device 22. However, in other embodiments, the cellular radio module 38 can be a separate add-on module connected to the hub device 22 via one or more electrical connectors. Furthermore, the cellular radio module 38 can include an electronic SIM card interface for flexible deployment with various cellular network providers. In some embodiments, the hub device 22 can be battery-powered and can include one or more buttons and status indicator lights for use in setting up and/or monitoring the operation, power status, and/or connectivity of the hub device 22. Furthermore, the hub device 22 can include a Bluetooth communication module 43 for enabling direct wireless communication with the cellular radio module 38 or the user device and the application 28 executed thereon for use in provisioning the hub device 22 and/or each of the plurality of sensors 24.

As seen in FIG. 2, the connected water monitoring system 20 can include a local database device 44 located in a region proximate to the hub device 22 and/or a remote database device 46 associated with the cloud server 26. In some embodiments, the local database device 44 can be integrated into the single housing with the hub device 22. Additionally or alternatively, in some embodiments, the local database device 44 can be separate from the hub device 22. In these embodiments, the hub device 22 can be configured to communicate with the local database device 44 via one or more of the WI-FI communication interface 34, the short-range communication module 36, the cellular radio module 38, the Bluetooth communication module 43, and/or other wired or wireless electronic communication methods known in the art. In some embodiments, the local database device 44 can be configured to store the historical values and/or the information received from any of the plurality of sensors 24 and not yet uploaded to the cloud server 22, and the remote database device 46 can be configured to store the values and/or the information received from any of the plurality of sensors 24 and uploaded from the hub device 22 to the cloud server 26.

According to embodiments disclosed herein, the cloud server 26 can be configured to execute an automatic maintenance process for the system 20. The automatic maintenance process can enable the service provider for the system 20, or the system 20 itself, to independently take action or perform a maintenance task with respect to the system 20 without the user (e.g. an owner of the system 20) having to initiate such action via a phone call or otherwise. For example, such independent action can include making repairs to the system 20, stopping or preventing leaks, scheduling maintenance for the system 20, etc.

Various embodiments for the automatic maintenance process are contemplated. In some embodiments, the cloud server 26 can first identify that there is a need for maintenance. For example, in some embodiments, the cloud server 26 can be configured to determine when the values and/or the information received from any of the plurality of sensors 24 indicate that components in the system 20 require some action or maintenance. This determination can be made by comparing the values and/or information received to threshold values that are stored, input, or calculated at the hub device 22 and/or the cloud server 26. In some embodiments, the cloud server 26 can be configured to determine that the values and/or the information received from any of the plurality of sensors 24 indicate that components in the system 20 require some action or maintenance when the values and/or the information received from any of the plurality of sensors 24 indicate that the system is currently performing below expected standards or, exceeding or not meeting a threshold value. Additionally or alternatively, in some embodiments, the cloud server 26 can be configured to determine that the values and/or the information received from any of the plurality of sensors 24 indicate that components of the system 20 require some action or maintenance when the values and/or the information received from any of the plurality of sensors 24 indicate that the system 20 will be performing below expected standards or a threshold level of operation at a future point in time by using predictive analyses.

The threshold values and/or expected standards can be identified and modified by the user via the user device and the application 28 executed thereon. The expected standards and/or threshold level of operation can be, for example, an amount of time in service, a flow rate value that is above or below a threshold flow rate value, a temperature value that is above or below a threshold temperature value, a pressure value that is above or below a threshold pressure value, a TDS value that is above or below a threshold TDS value, a salt level value that is above or below a threshold salt level value, a leak value that is above or below a threshold leak value, a bypass value that is above or below a threshold bypass value, a battery level value that is above or below a threshold battery level value, or any other sensed value described herein that is above or below a set threshold value with respect to that sensed value. Further, the expected standards and/or threshold level of operation can apply to the system 20 as a whole or specific component therein, such as filters, valves, pumps, the plurality of sensors 24 themselves, water softeners, reverse osmosis systems, or commercial equipment such as beverage machines, ice machines, steam machines, dishwashers, and the like. Still further, although specific values and threshold values are contemplated and disclosed, it is further contemplated that a measured value may be compared to a threshold range of values. In this way, an individual value may be determined to fall inside or outside the threshold range, which indicates a normal operating condition.

In some embodiments, after the cloud server 26 identifies the action or maintenance needed for the system 20, such as repairs to and/or replacements of components of the system 20, the cloud server 26 can execute the automatic maintenance process by notifying the service provider and/or the user of the action or maintenance needed by transmitting a notification of such need for action or maintenance from the cloud server 26 to the service provider and/or the user. In some embodiments, the specific service provider(s) associated with the system 20 can be preconfigured such that the service provider device and the application 30 executed thereon are associated with the system 20. In these embodiments, the notification can be sent to the service provider device and the application 30 executed thereon and/or the user device and the application 28 executed thereon and can include a listing of the repairs to, and/or the replacement of, various components.

Additionally or alternatively, in some embodiments, when the cloud server 26 predicts that the system 20 will be performing below the expected standards or the threshold level of operation at the future point in time, or that some component will reach an end-of-life condition at the future point in time, the cloud server 26, in anticipation of the end of life, can be configured to automatically order a replacement part for that component via the service provider device and the application 30 executed thereon or the user device and the application 28 executed thereon such that the replacement part is delivered or otherwise becomes available on or before the future point in time and without any further action by the user. For example, some specific, but non-limiting examples of the automatic maintenance process can include the cloud server 26 and/or the service provider device and the application 30 executed thereon and/or the user device and the application 28 executed thereon ordering replacement filter cartridges from a designated supplier, ordering new batteries for the hub device 22 and/or any of the plurality of sensors 24, and/or notifying the user device and the application 28 executed thereon and/or the service provider device and the application 30 executed thereon that a filter cartridge needs to be rotated.

In some embodiments, the service provider device and the application 30 executed thereon can be used by a service provider to initiate the automatic maintenance process independently from the user and the user device and the application 28 executed thereon. For example, in some embodiments, the service provider device and the application 30 executed thereon can initiate the automatic maintenance process by periodically querying the cloud server 26 to determine whether any action or maintenance is needed for the system 20. In these embodiments, the cloud server 26 can determine whether the action or maintenance is needed in response to the query from the service provider device and the application 30 executed thereon. Additionally or alternatively, in these embodiments, the cloud server 26 can identify the action or maintenance needed for the system 20 before the query is received and transmit a notification thereof in response to the query.

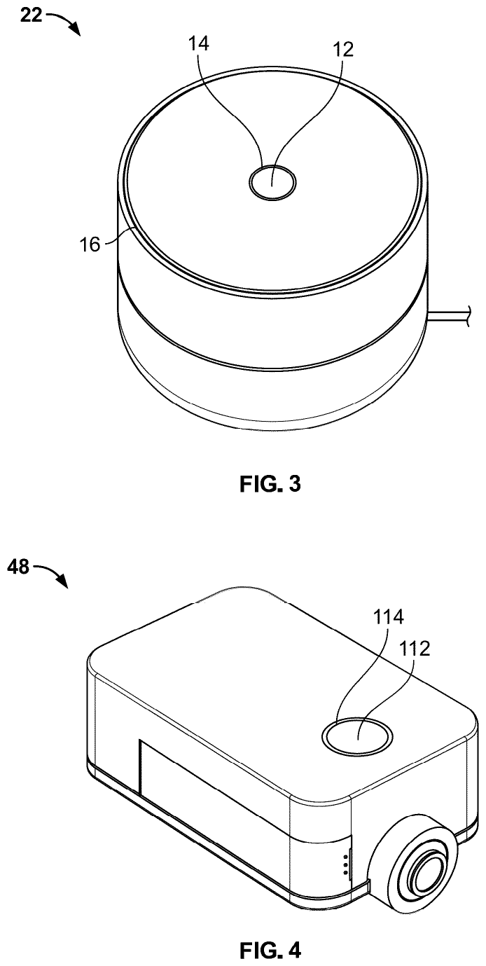

FIG. 3 illustrates the hub device 22 according to an embodiment. The hub device 22 can be provided in the form of a cylindrical housing and includes a light ring 16 around the outer perimeter of the top surface. The hub device 22 also includes a push button 12, and in some embodiments, a button light ring 14. The push button 12 can be used to perform various actions by way of a single short press, multiple short presses, or a timed press and hold sequence. In one instance, for example, a single short press or multiple short presses can initiate WI-FI provisioning such that the cellular radio module 38 can communicate WI-FI credentials with the hub device 22 via the short-range communication module 36 so that the WI-FI communication interface 34 can send and receive data from the internet. In another instance, the hub device 22 can be prompted to connect with one or more of the plurality of sensors 24 when the push button 12 is pressed one or more times. In some instances, a system hard reset can be initiated when the push button 12 is held down for more than a predetermined period of time, such as 10 seconds. The hard reset can include resetting all user set parameters back to a factory default and/or resetting the short-range communication module 36, the WI-FI communication interface 34, and/or the Bluetooth communication module 43. In some forms, a soft reset can be initiated when the push button 12 is held down for more than a second predetermined amount of time, such as 5 seconds. The soft reset can include resetting only a portion of the parameters reset by way of the hard reset, such as only some of the user-set parameters, only the WI-FI communication interface 34, etc.

In some embodiments, the light ring 16 includes a plurality of colored LEDs or illumination elements and/or a light diffuser ring and can provide selective illumination in various patterns based on the operational conditions of the system 20. For example, the light ring 16 can provide illumination with a color, such as red, green, blue, orange, yellow, red, etc., as well as a pattern such as blinking or continuous illumination. The selective illumination of the light ring 16 can correspond to conditions such as lack of network connection of the hub device 22, system hard reset initiated, system soft reset initiated, WI-FI connection in progress and/or successful WI-FI connection of the hub device 22, cellular connection in progress and/or successful cellular connection, and/or communicative connection between the hub device 22 and one or more of the plurality of sensors 24 being in the progress of connecting or successfully established. Accordingly, users can be notified as to the conditions of the system 20 by viewing the selective illumination of the light ring 16. In some forms, the button light ring 14 also includes a plurality of colored LEDs and lights up in tandem with the light ring 16 in the same color and pattern for an added visual effect.

FIG. 4 illustrates the TDS sensor 48 according to an embodiment. The TDS sensor 48 is provided in the form of a rectilinear housing having a port disposed on an end thereof designed to receive a water sample. The housing can include a push button 112 disposed in a surface thereof, and in some embodiments, a button light ring 114. The push button 112 can be used to perform various actions by way of a single short press, multiple short presses, or a timed press and hold sequence. In one instance, for example, a single short press or multiple short presses can initiate a communicative connection between the short-range communication module 36 of the TDS sensor 48 and the short-range communication module 42 of the hub device 22. In another instance, the TDS sensor 48 can take a TDS measurement and/or a temperature measurement and send the measurement(s) to the hub device 22 in response to one or more short button presses. In some instances, a troubleshooting mode can be initiated when the push button 112 is held down for more than a predetermined period of time, such as 10 seconds. The troubleshooting mode can include taking and/or sending TDS and temperature measurements rapidly, such as every two seconds for a set period of time.

In some embodiments, the light ring 116 includes a plurality of colored LEDs and can provide selective illumination in various patterns based on conditions of the TDS sensor 48. For example, the light ring 116 can provide illumination with a color, such as red, green, blue, orange, yellow, red, etc., as well as a pattern such as blinking or continuous illumination. The selective illumination of the light ring 116 can correspond to conditions such as an error condition, proper operation, TDS is in the appropriate range, the troubleshooting mode being active, a communicative connection between the TDS sensor 48 and the hub device 22 in progress of connecting or successfully established, or a wake-up and connect protocol with the hub device 22. Examples of error conditions include a low battery condition, sensed TDS is out of an acceptable range, or communication errors, such as between the TDS sensor 48 and the hub device 22. Accordingly, users can be notified as to the conditions of the TDS sensor 48 by viewing the selective illumination of the light ring 116. In some forms, the TDS sensor 48 includes firmware that limits the function of the TDS sensor 48 based on the remaining battery life. For example, if the battery voltage is equal to, or less than a first threshold, the TDS sensor 48 will not perform internal calibrations or provision communication with the hub device 22. Further, a low battery notification can be sent to the user device and the application 28 executed thereon and/or the service provider device and the application 30 executed thereon via the hub device 22. When the battery voltage is equal to, or less than, a second threshold, the TDS sensor 48 will not power on or wake up.

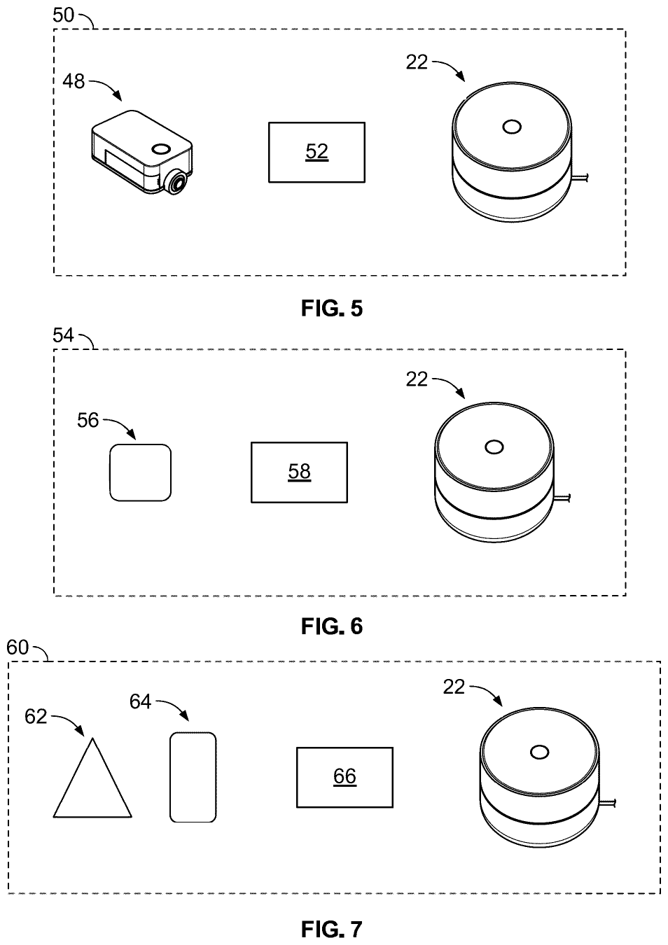

According to disclosed embodiments, the hub device 22 and one or more of the plurality of sensors 24 can be included in one or more kits to simplify a setup and/or retrofit procedure for the system 20. As seen in FIGS. 5-8, in some embodiments, the kits can include one or more of a plurality of kits 50, 54, 60, 68, and in some embodiments, each of the plurality of kits 50, 54, 60, 68 can include a unique identifier associated therewith that the user device and the application 28 executed thereon can use to retrieve detailed setup instructions for the hub device 22 and each of the plurality of sensors 24 in that kit. In some embodiments, the unique identifier can include a code or icon on or associated with a particular kit that can be electronically scanned by the user device and the application 28 executed thereon to retrieve the detailed setup instructions.

In some embodiments, the plurality of kits 50, 54, 60, 68 can include different groupings and types of the plurality of sensors 24 that can be tailored to one or more different types of filter systems. For example, in some embodiments, the kit 50 shown in FIG. 5 can be configured for a small or medium water filtration system, and the plurality of sensors 24 can include the TDS sensor 48 and coordinated installation fittings and adaptors 52 therefor. In these embodiments, the system 20 can be configured to monitor basic water quality, produce a filter end-of-life reminder on a time tracking basis, and calculate a remaining life percentage of the filter.

Additionally or alternatively, in some embodiments, the kit 54 shown in FIG. 6 can be configured for adding to, or retrofitting, connected monitoring to existing filtration systems, such as the Claris® system supplied by Everpure®, and the plurality of sensors 24 can include the low flow sensor 56 and coordinated installation fittings and adaptors 58 thereof. In these embodiments, the system 20 can be configured to monitor filter life based on water volume and standard tables associated with the Claris® system stored on the hub device 22 and/or the cloud server 26.

Additionally or alternatively, in some embodiments, the kit 60 shown in FIG. 7 can be used for adding to or retrofitting existing single head or multi head filtration systems, with and without prefilters, and the plurality of sensors 24 can include the pressure sensor 62, the high flow sensor 64, and coordinated installation fittings and adaptors 66 therefor. In these embodiments, the system 20 can be configured to monitor for one or more of the water pressure value being outside of a desired range, the differential pressure to determine whether a filter cartridge change is needed, and water pressure fluctuation.

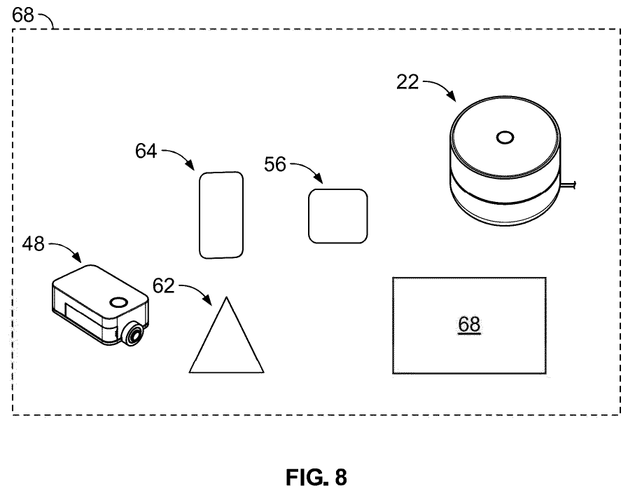

Additionally or alternatively, in some embodiments, the kit 68 shown in FIG. 8 can be configured for a large filtration system, such as a reverse osmosis commercial system, and the plurality of sensors 24 can include at least two TDS sensors 48, at least two flow meter sensors, such as the low flow sensor 56 and/or the high flow sensor 64, at least two pressure sensors 62, and coordinated installation fittings and adaptors 68 therefor. In these embodiments, the system 20 can be configured to monitor one or more of a total gallon capacity (prefilter), total water usage, inlet flow, RO/blend flow, the total dissolved solids outside of a desired range for RO and blend, fluctuation of the total dissolved solids, whether any portion of the system 20 has been bypassed, whether a system pump has died or is reaching its end of life, and/or whether or not a prefilter is clogged.

In some embodiments, the setup instructions can include instructions for downloading a default configuration setting to the hub device 22 from the user device and the application 28 executed thereon and/or the cloud server 26. In these embodiments, the default configuration setting can include initial settings for the hub device 22 that account for each of the plurality of sensors 24 in that kit 50, 54, 60, 68. Additionally or alternatively, in some embodiments, the detailed setup instructions can include a preinstallation check list for the hub device 22 and each of the plurality of sensors 24 in that kit 50, 54, 60, 68 and step by step installation instructions that identify a respective installation location for each of the plurality of sensors 24 and/or the hub device 22 in that kit 50, 54, 60, 68. Additionally or alternatively, in some embodiments, the detailed setup instructions can instruct and facilitate the user device and the application 28 executed thereon documenting an installation date of the hub device 22 and each of the plurality of sensors 24 in that kit 50, 54, 60, 68, the respective installation location of each of the plurality of sensors 24 within the system 20, a physical address of the system 20, and/or other details about the system 20 and the components thereof.

Additionally or alternatively, in some embodiments, the detailed setup instructions can instruct and facilitate receiving user input via the user device and the application 28 executed thereon defining one or more user accounts that have electronic access to the values and/or the information received from each of the plurality of sensors 24 and stored at the hub device 22 and/or the cloud server 26, which of the one or more user accounts should be notified for various system alerts or alarms in the system 20, preferred notification methods for the one or more user accounts, such as e-mail, application push notifications, text messages, local alarms, or similar methods known in the art, a listing of qualified and/or preapproved service providers to use when providing the automatic maintenance process for the system 20, and/or the destination of the water monitored by the system 20 or the type of application in which the system 20 is used. In some forms, the water destination can be selected between hot applications such as hot water or tea, cold applications such as ice, steam applications such as dishwashers and combination ovens, and specified beverage applications such as coffee machines or fountain drink dispensers. The selected end water destination can change how information from the plurality of sensors 24 is interpreted by the hub device 22 and/or the cloud 26, such as changing acceptable thresholds for TDS, temperature, pressure, flow, etc. In some forms, the application 28 executed thereon and/or the service provider device and the application 30 executed thereon can be configured to aggregate information between multiple systems 20 in multiple applications, such that the application 28 and the application 30 can be used to monitor water delivery to multiple residences, locations, or stores monitored by the same entity.

According to disclosed embodiments, the user device and the application 28 executed thereon can be configured to set up the system 20 as described above and to monitor the operation of the system 20 as described in more detail below. In this regard, in some embodiments, the user device and the application 28 executed thereon can be configured to connect and communicate with the hub device 22 via the cloud server 26 and the internet. Additionally or alternatively, in some embodiments, the user device and the application 28 executed thereon can be configured to connect to and communicate with the hub device 22 via a direct connection using one or more of the WI-FI communication interface 34, the short-range communication module 36, the cellular radio module 38, the Bluetooth communication module, and other wired or wireless electronic communication methods known in the art.

The user device and the application 28 executed thereon can include various electronic devices, such as a mobile phone, tablet, personal computer, etc., and the application 28 executed on the user device can include a dedicated application or web based application that can interface with the hub device 22 and the cloud server 26 to enable the user to view the values and/or the information received from any of the plurality of sensors 24, control various operations of the system 20 such as the smart components or other related equipment, set up or configure the system 20, view notifications regarding alarm or other alert conditions for the system 20 and/or the automatic maintenance process, and/or monitor a status of the automatic maintenance process being executed by the cloud server 26.

Similarly, the service provider device and the application 30 executed thereon can be configured to communicate with the cloud server 26 as described herein. In this regard, in some embodiments, the service provider device and the application 30 executed thereon can be configured to connect to and communicate with the hub device 22 via the cloud server 26 and the internet. In any embodiment, the service provider device and the application 30 executed thereon can include various electronic devices, such as a mobile phone, tablet, personal computer, virtual server, etc., and the application 30 executed on the service provider device can include a dedicated application or web based application that can interface with the cloud server 26 to enable the service provider to view the values and/or the information received from any of the plurality of sensors 24, control various operations of the system 20 such as the smart components or other related equipment, set up the system 20, view notifications regarding alarm or other alert conditions for the system 20 and/or the automatic maintenance process, initiate the automatic maintenance process, and/or communicate with the cloud server 26 while the cloud server executes the automatic maintenance process.

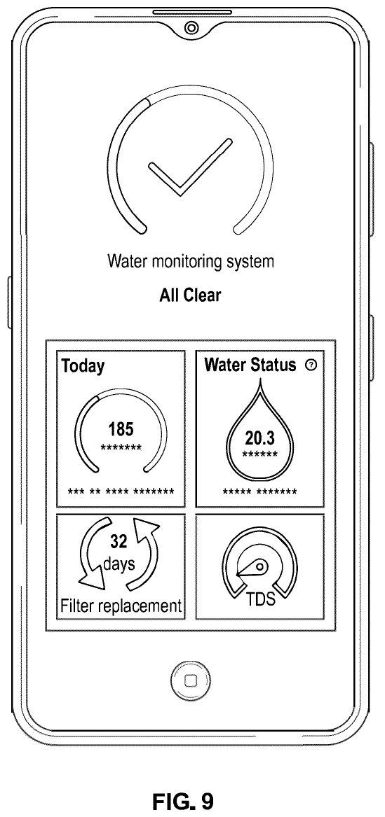

In some embodiments, the user device and the application 28 executed thereon and/or the service provider device and the application 30 executed thereon can include and be configured to display a dashboard page, such as shown in FIG. 9, which can summarize historical, current, and relevant data for the system 20. In some embodiments, the dashboard page can include one or more notifications or indicators including a water quality summary, an equipment summary, a predictive service and cartridge change summary, an estimate of the percentage life/time remaining on one or more components of the system 20 such as the plurality of sensors 24, the hub device 22, the smart components, or other related equipment such as pumps or filters, and/or a device summary documenting whether current values received from any of the plurality of sensors 24 are out of range (e.g. low TDS level, high TDS level, low pressure, high pressure, high differential pressure, etc.), whether the hub device 22 is unplugged or not network connected, and in some embodiments, a salt supply status. In some embodiments, when the service provider device and the application 30 executed thereon display the dashboard page, the dashboard page can include additional or alternative information, such as, for example, information only relevant to the service provider.

In some embodiments, the relevant data summarized on the dashboard page can include the contextualized reports and/or the user interface graphics and can quickly and intelligibly inform the service provider and/or the user about the status of the system 20 and any of its various sub-components in addition to or in lieu of a display of the values and/or the information received from any of the plurality of sensors 24. For example, if the system 20 includes a removable filter cartridge or other periodically replaceable component, then the contextualized reports can display one of a plurality of preconfigured states of a graphic or text that indicates whether or not it is time to replace the removable filter cartridge or other periodically replaceable component. In this regard, a first of the plurality of preconfigured states of the graphic or text can indicate that it is time to replace the removable filter cartridge, and a second of the plurality of preconfigured states of the graphic or text can indicate that there is no current need to replace the removable filter cartridge.

In some embodiments, the display of a particular preconfigured state of the graphic or text can be identified based on different ones of the values and/or the information received from each of the plurality of sensors 24. For example, in some embodiments, the hub device 22 and/or the cloud server 26 can execute backend calculations, including those described in connection with the automatic maintenance process, to determine which of the plurality of preconfigured states of the graphic or text to display, and in some embodiments, which of the back end calculations to execute can be determined at least in part on which specific sensor types are being utilized by the plurality of sensors 24. Nevertheless, in some embodiments, the graphic or text itself and the plurality of preconfigured states thereof that can be displayed can be the same irrespective of the backend calculations executed and the sensor types in the plurality of sensors 24.

As a specific, but non-limiting example, when the system 20 includes the sensors 24 from the kit 50, the hub device 22 and/or the cloud server 26 can use a virtual timer to measure how long the removable filter cartridge has been in use and, in response thereto, identify when the removable filter cartridge needs to be replaced and, accordingly, when to display the one of the plurality preconfigured states of the graphic or text that indicates that it is time to replace the removable filter cartridge. Additionally or alternatively, when the system 20 includes the sensors 24 from the kits 54, 60, or 68, the hub device 22 and/or the cloud server 26 can compare the information received from the low flow sensor 56, the high flow sensor 64, and/or the pressure sensor 62 to threshold filter values associated with a degraded filter cartridge and, responsive thereto, determine when the filter cartridge needs to be replaced and, accordingly, when to display the one of the plurality of preconfigured states of the graphic or text that indicates that it is time to replace the removable filter cartridge.

As seen in FIG. 9, in some embodiments, one of the contextualized reports can include an overall status graphic that can summarize a total statistic of the system 20 based on all of the calculated values and/or the information received from each of the plurality of sensors 24. For example, in some embodiments, the overall status graphic can include a first state, such as a check mark, that indicates the system 20 is operating correctly, and a second state, such as an X, that indicates the system 20 (or one of its components) is operating incorrectly. Additionally or alternatively, in some embodiments, the overall status graphic can include a graduated indicator of system status, such as a dial in which a first side of the dial indicates full health of the system 20, a second side of the dial indicates that one or more of the components of the system 20 are inoperable, and continuous areas between the first side and the second side indicate varying degrees of health and/or inoperability of the system 20 and the components thereof or associated equipment. As described above, the hub device 22 and/or the cloud server 26 can execute backend calculations, including those described in connection with the automatic maintenance process, to determine the state or the graduated indicator of the overall status graphic. Further, the hub device 22 and/or the cloud server 26 can determine which of the backend calculations to execute based at least in part on which types of sensors 24 are active in the system 20. Nevertheless, in some embodiments, the overall status graphic itself and the state or the graduated indicator thereof that can be displayed can be the same irrespective of the backend calculations executed and the sensor types in the plurality of sensors 24.

In some embodiments, the hub device 22 and/or the cloud server 26 can be configured to monitor the information received from each of the plurality of sensors 24 over a first period of time to identify normal or baseline operation of the system 20. For example, the hub device 22 and/or the cloud server 26 can identify consistent regular patterns in the information received from each of the plurality of sensors 24 that are indicative of the normal operating conditions of the systems 20 to develop various threshold values and operating parameters against which future information received from each of the plurality of sensors 24 can be compared. Accordingly, once the hub device 22 and/or the cloud server 26 establish the normal or baseline operation of the system 20, the hub device 22 and/or the cloud server 26 can monitor the information received from each of the plurality of sensors 24 for non-standard deviations from the normal or baseline operation that indicate either a degradation in a specific component of the system 20 and/or a general degradation in the overall health of the system 20. Then, the hub device 22 and/or the cloud server 26 can update the contextualized reports, including the overall status graphic, to reflect the non-standard deviations from the normal, baseline, or threshold level of operation. Alternatively, baseline operating parameters of the system 20 may be preloaded or otherwise input into a controller of the system 20.

In some embodiments, the contextualized reports can include different values of the information received from each of the plurality of sensors 24 over multiple time periods. For example, in some embodiments, the contextualized reports can show a cumulative total value for the information received from some of the plurality of sensors 24 or one of the values calculated therefrom over a specified time period. A non-limiting example of such a cumulative total can include a total amount of water used by the system over a specified time period. Additionally or alternatively, in some embodiments, the contextualized reports can highlight changes in the information received from some of the plurality of sensors 24 or one of the values calculated therefrom over a specified time period. Some non-limiting examples can include identifying peak values for the information received from some of the plurality of sensors 24 or one of the values calculated therefrom and/or time periods when those peak values occur.

Additionally or alternatively, in some embodiments the hub device 22 and/or the cloud server 26 can be configured to send or display on the dashboard page urgent notifications or alerts to the user of the system 20 based on one or more of the information received from each of the plurality of sensors 24, the values calculated therefrom, and/or time based trends of the information or values. Some non-limiting example notifications or alerts can include an alert for a plumbing issue resulting from a change in water temperature (e.g. an increased risk of pipes freezing from abnormally cold water), an alert for a plumbing issue from low water flow through the system 20, an alert that the water supply has been shut down for an extended period of time, an alert corresponding to the detection of water hammering in the system 20 via one or more pressure sensors or quick state changes in smart valves, and an alert corresponding to no or low salt being present in a brine tank. Furthermore, in some embodiments, the notification or alert can include detailed instructions documenting how the user can correct or mitigate the condition responsible for generating the notification or alert. For example, in some embodiments, the hub device 22 and/or the cloud server 26 can recommend and provide instructions for how to quickly change or purge the water in the system 20 when required by a repair event that dumps or contaminates water in the system 20, restart the system 20 after a long water shutdown period, take steps for lowering recovery when the salt level in the brine tank is low or at zero, and/or initiate specific improvements to plumbing for the system 20 to correct the low flow issue.

In some forms, the preconfigured states of the graphic or text to display or other notifications provided by the user device and the application 28 executed thereon and/or the service provider device and the application 30 executed thereon can be altered by, or indicate, a level of urgency. For example, notifications that are critical, such as a leak detected, no flow, low pressure, etc. can be displayed in red, and alerts sent to preferred notification methods can be delivered in real-time at any time of the day. Alerts that are less critical can be displayed in orange or yellow, for example, such as lost connectivity of the sensors 24 or the salt level is getting low, and alerts sent to preferred notification methods can be delivered only during specific times, such as from 9:00 am-5:00 am in the user's time zone.

In some embodiments, the hub device 22 and/or the cloud server 26 can be configured to gather data from external data sources and correlate that information with one or more of the information received from each of the plurality of sensors 24, the values calculated therefrom, and/or time based trends of the information or values to populate the dashboard with the most accurate information and/or to properly contextualize the information received from each of the plurality of sensors 24, the values calculated therefrom, and/or time based trends of the information or values. For example, in some embodiments, the hub device 22 and/or the cloud server 26 can be configured to gather or data mine water studies of the municipal water supply for the system 20. In these embodiments, the hub device 22 and/or the cloud server 26 can correlate the mined data with information, values, and time based analyses related to the TDS sensor 48 to, for example, better set the baseline or normal operating TDS values in the system 20.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A connected water monitoring system comprising:
a plurality of sensors, each of which monitors a respective condition;
a hub device configured to receive and store respective information from each of the plurality of sensors indicative of a current status of the respective condition monitored by a respective one of the plurality of sensors; and
a cloud server configured to communicate with the hub device via a network,
wherein the respective information includes one or more values sensed by each of the plurality of sensors,
wherein the hub device is configured to transmit one or both of the one or more values or the respective information from each of the plurality of sensors to the cloud server,
wherein the cloud server is configured to determine when one or both of the one or more values or the respective information from each of the plurality of sensors indicate that one or more connected water monitoring system components require maintenance and, responsive thereto, execute an automatic maintenance process.

2. The connected water monitoring system of claim 1, wherein the hub device includes an application program interface through which the one or more values are set or updated via a user device connected to the hub device via one or both of the cloud server or a direct network connection.

3. The connected water monitoring system of claim 1, wherein the plurality of sensors include one or more of a total dissolved solids sensor, a flow meter, a pressure meter, a temperature sensor, or a salt level sensor.

4. The connected water monitoring system of claim 1 further comprising:
a kit that includes the plurality of sensors and the hub device, wherein the kit includes a unique identifier associated therewith.

5. The connected water monitoring system of claim 4 further comprising:
a user device configured to scan the unique identifier and use the unique identifier to retrieve a setup procedure for the hub device and the kit.

6. The connected water monitoring system of claim 5, wherein the setup procedure includes instructions for uploading a default configuration for the hub device from one or both of the user device or the cloud server, and wherein the default configuration includes initial hub device settings for each of the plurality of sensors.

7. The connected water monitoring system of claim 6, wherein the default configuration is correlated to whether the system is being used for a food application, a beverage application, a filter application, a water softening, or conditioning application.

8. The connected water monitoring system of claim 1, wherein the cloud server is configured to determine that one or both of the one or more values or the respective information from each of the plurality of sensors indicate that the one or more connected water monitoring system components require maintenance when one or both of the one or more values or the respective information from each of the plurality of sensors indicate that the system is currently performing below a threshold level of operation.

9. The connected water monitoring system of claim 1, wherein the cloud server is configured to determine that one or both of the one or more values or the respective information from each of the plurality of sensors indicate that the one or more connected water monitoring system components require maintenance when one or both of the one or more values or the respective information from each of the plurality of sensors indicate that the system will be performing below a threshold level of operation at a future point in time.

10. The connected water monitoring system of claim 1, wherein the automatic maintenance process includes the cloud server identifying one or more of repairs to or replacements of the one or more connected water monitoring system components and transmitting a maintenance notification to a service provider, and wherein the maintenance notification includes a list of the one or more of repairs to or replacements of the one or more connected water monitoring system components.

11. The connected water monitoring system of claim 8, wherein when the cloud server determines that the system will be performing below the threshold level of operation at the future point in time, the automatic maintenance process includes determining that the one or more connected water monitoring system components will reach an end of life condition at the future point in time, and ordering a replacement of the one or more connected water monitoring system components such that the replacement is delivered on or before the future point in time.

12. A method of monitoring a water flow system, comprising:
providing a connected water monitoring system having a sensor and a hub device configured to receive information from the sensor indicative of a current status of the water flow system;
sensing, with the sensor, one or more values corresponding to water flowing through the water flow system;
transmitting the one or more values to the hub device;
transmitting the one or more values from the hub device to a cloud server;
analyzing the one or more values to predict whether one or more components of the water flow system will perform below a threshold level of operation at a future point in time; and
sending a notification that indicates an action to be taken prior to the future point in time.

13. The method of claim 12, wherein the action comprises replacing a filter cartridge.

14. The method of claim 12, wherein the action comprises shutting off a valve.

15. The method of claim 12, wherein the action comprises replacing a battery of the sensor.

16. The method of claim 12, wherein the hub device includes a light ring, and the method further includes illuminating the light ring based on the current status of the water flow system or based on a connectivity status between the sensor and the hub device.

17. The method of claim 12, further comprising generating a contextualized report over multiple time periods based on the one or more values corresponding to water flowing through the water flow system.

18. The method of claim 12, wherein the action is initiated automatically by the connected water monitoring system.

19. The method of claim 18, wherein the action comprises automatically increasing production of a reverse osmosis component of the water flow system.

20. The method of claim 19, wherein the action comprises modifying a function of a smart component of the water flow system.
